(19) United States
(12) Patent Application Publication
(10) Pub. No.: US 2002/0038562 A1
(43) Pub. Date: Apr. 4, 2002

(54) Novelty golf club and steering wheel lock

(76) Inventor: Brian K. Lang, Darnestown, MD (US)

Correspondence Address: Richard C. Litman, LITMAN LAW OFFICES, LTD., P.O. Box 15035, Arlington, VA, 22215, US

(21) Appl. No.: 09/968,535

(22) Filed: Oct. 2, 2001

Related U.S. Application Data
(60) Provisional application No. 60/236,724, filed on Oct. 2, 2000.

(51) Int. Cl. F16C 3/00; G05G 5/00

(52) U.S. Cl. 70/209

(57) ABSTRACT

The invention is a novelty golf club and steering wheel lock made up of a club head, shaft, hand grip, and two opposing attachment hooks. The shaft is made up of a lower standard portion and wider upper sleeve portion. The shaft has a lower standard portion attached to and extending from the club head and sliding into an upper sleeve portion which continues to extend upward to form the hand grip. The length of the novelty golf club and steering wheel lock is adjusted by selectively adjusting the upper sleeve relative to the lower standard. This is done with a plurality of holes formed on the lower standard, a hole near the edge of the upper sleeve, and a locking pin designed as a golf tee to be inserted in the hole near the edge of the upper sleeve and a selected and aligned hole from the plurality of holes on the lower standard.

### CROSS-REFERENCE TO RELATED APPLICATION

This application claims the benefit of U.S. Provisional Patent Application Serial No. 60/236,724, filed Oct. 2, 2000.

### BACKGROUND OF THE INVENTION

1. Field of the Invention

The present invention relates generally to a steering wheel lock. More specifically, the invention is a novelty golf club serving as a steering wheel lock device.

2. Description of Related Art

“The Club” is a relatively simple device that locks the steering wheel of most any vehicle in place, preventing use of the protected vehicle until the device is unlocked by its owner. Similar auto theft deterrent devices have been copied as criminal deterrents as well as novelty items. These are reflected in the related art, which outlines functionally similar auto theft deterrents and novelty spin offs.

The related art of interest will be discussed in the order of perceived relevance to the present invention.

U.S. Design Pat. No. 399,410 issued on Oct. 13, 1998, to Darius C. Chelaru describes an ornamental design of a steering wheel lock in the shape of a golf club driver having two hooks. The upper hook is located on a separate segment having an internally corrugated portion and a protruding key lock. The lower hook is located on a bar with a corrugated ratchet teeth portion which has an oval cross-section rather than a circular cross-section. The hooks are noticeably large and thick. However, the similarity to a driver club is deficient, because the handle portion does not resemble any golf club handle as in the present invention. Therefore, Chelaru's ornamental driver is distinguishable for its club head, its massive hooks, the non-cylindrical connection, and the key lock.

U.S. Design Pat. No. 399,409 issued to Darius C. Chelaru on Oct. 13, 1998, describes an ornamental design of a steering wheel lock in the shape of a baseball bat with identical hooks, lock and attachment configuration. U.S. Design Pat. No. 399,411 issued ot Darius C. Chelaru on Oct. 13, 1998, describes an ornamental design of tennis racket shaped steering wheel lock with identical hooks, lock and attachment configuration. U.S. Design Pat. No. 399,412 issued to Darius C. Chelaru on Oct. 13, 1998, describes the ornamental design of steering wheel lock in the shape of a hockey stick with identical hooks, lock and attachment configuration. These ornamental designs are distinguishable as the golf club design for the same reasons given above.

U.S. Pat. No. 5,836,185 issued on Nov. 17, 1998, to Renato M. Openiano describes a telescoping vehicle anti-theft device having a third hook which independently telescopes relative to the first two hooks so as to span a remaining portion of the diameter of the steering wheel and engage the wheel rim at a point opposite to the where the first two parts are located. The device is distinguishable for requiring a third locking hook.

U.S. Pat. No. 5,865,044 issued on Feb. 2, 1999, to Jinn F. Wu describes a steering wheel lock device having two hooks combining by the corrugated ratchet teeth positioned in a large triangular shaped key lock portion. The longer end has a handle grip. The device is distinguishable for its handle grip and triangular lock portion.

U.S. Pat. No. 5,970,758 issued on Oct. 26, 1999, to Wen-Chaun Chen outlines the use of a vehicle steering lock which includes a body member, a housing, a handle grip, and a locking means. The locking means is contained in a lock housing and consists of a base, a plural number of buttons, a press button, an adjust plate, plural wheels, a control plate, a press plate, a coil spring, and a deadbolt. This lock needs no keys and the coded number is adjustable by a user, thereby preventing the lock from being pried open by thieves. The steering lock is distinguishable for requiring a special locking means at one end and no hooks.

None of the above inventions and patents, taken either singly or in combination, is seen to describe the instant invention as claimed.

### SUMMARY OF THE INVENTION

The invention is a novelty golf club and steering wheel lock, made up of a club head, shaft, hand grip, and two opposing attachment hooks. The shaft is made up of a lower standard portion and wider upper sleeve portion. The shaft has a lower standard portion attached to and extending from the club head and sliding into an upper sleeve portion which continues to extend upward to form the hand grip of a golf club. The length of the novelty golf club and steering wheel lock is adjusted by selectively adjusting the upper sleeve relative to the lower standard. This is done with a plurality of holes formed on the lower standard, a hole near the edge of the upper sleeve and a locking pin designed to be inserted in the hole near the edge of the upper sleeve and a selected and aligned hole from the plurality of holes on the lower standard. The novelty golf club and steering wheel lock is readily attached to the steering wheel of a vehicle with the pair of adjustable opposing hooks.

Accordingly, it is a principal object of the invention to provide a novelty golf club and steering wheel lock.

It is another object of the invention to provide a gag or joke item for user fun and enjoyment.

It is a further object of the invention to provide a nonfunctioning novelty golf item that is fun and easy to adjust.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a novelty golf club and steering wheel lock on a vehicle steering wheel according to the present invention.

FIG. 2 is a side elevational view of a novelty golf club and steering wheel lock according to the present invention.

FIG. 3 is a partial side elevational view of a shaft of a novelty golf club and steering wheel lock according to the present invention.

FIG. 4 is a partial side elevational view of the upper attachment hook on the upper sleeve according to the present invention.

FIG. 5 is a partial side elevational view of the joint portion of the shaft of a novelty golf club and steering wheel lock according to the present invention.

Similar reference characters denote corresponding features consistently throughout the attached drawings.

### DETAILED DESCRIPTION OF THE PREFERRED EMBODIMENT

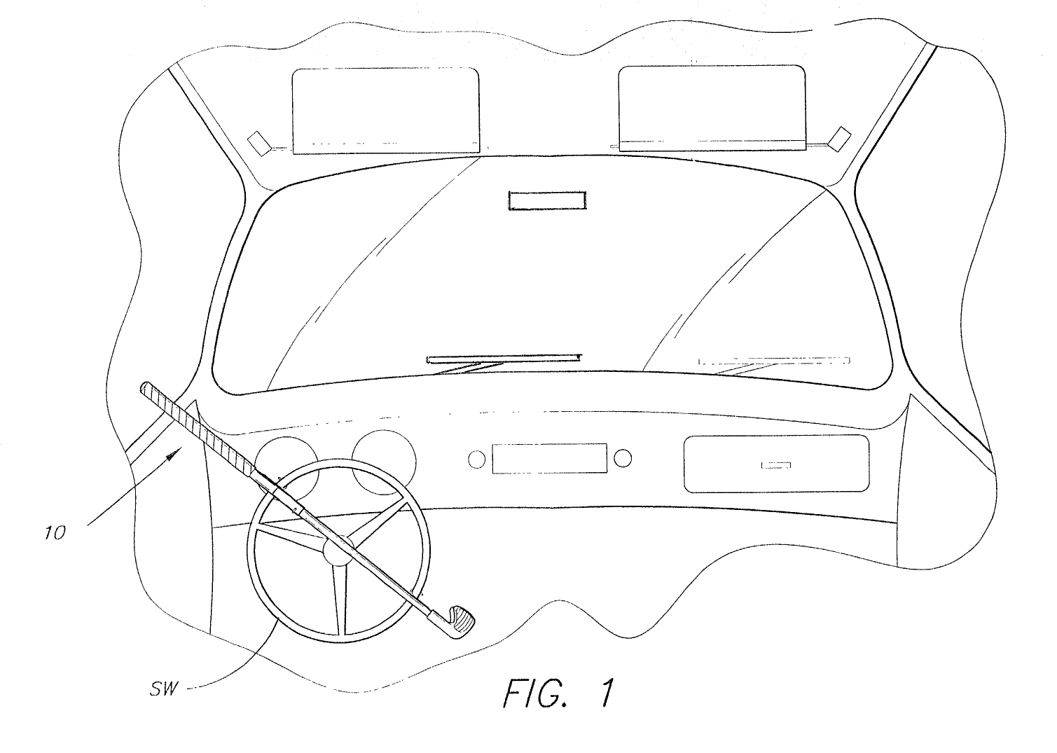

The present invention is a novelty golf club and steering wheel lock device 10, which is used with the steering wheel SW of a vehicle, as shown in FIG. 1.

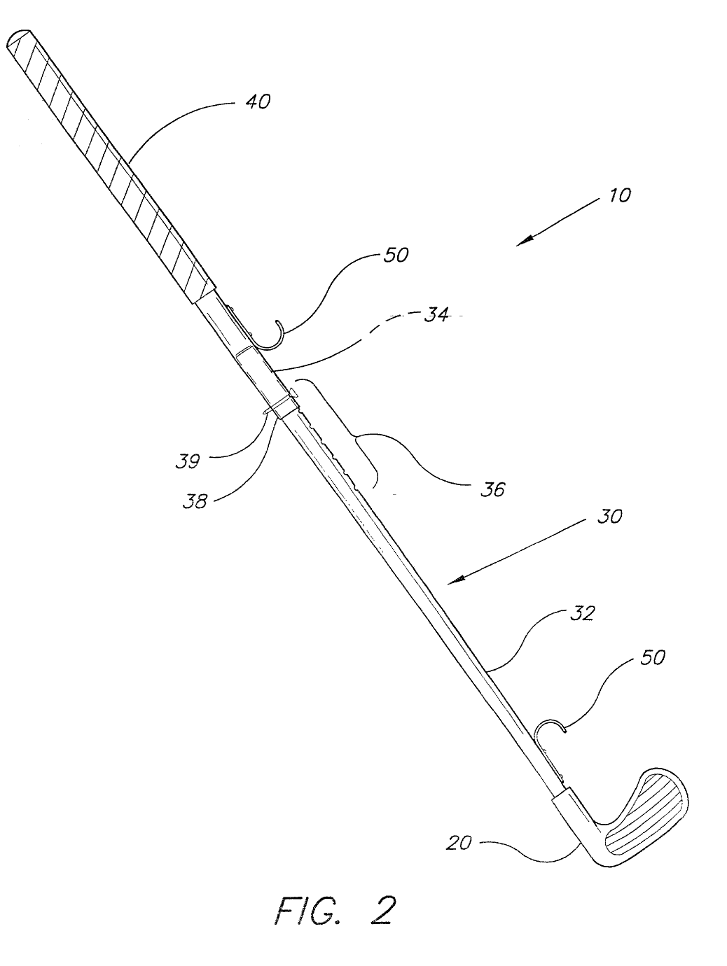

The novelty golf club and steering wheel lock device 10 in FIG. 2 is comprised of a putter club head 20, a club shaft 30 and a hand grip 40. The shaft 30 has a lower standard portion 32 attached to and extending from the club head 20 and sliding into a wider upper sleeve portion 34, which continues to extend upward to form the hand grip 40. There is a plurality of holes 36 on the lower standard 32, a locking pin tee 39, and a pair of adjustable opposing hooks 50 on the novelty golf club and steering wheel lock device 10.

There is also an adjusting means for selectively adjusting the position of the upper sleeve 34 relative to the lower standard 32 of the novelty golf club and steering wheel lock device 10 to fit onto the steering wheel SW of a vehicle, and a securing means for securing the novelty golf club and steering wheel lock device 10 to the steering wheel SW of a vehicle.

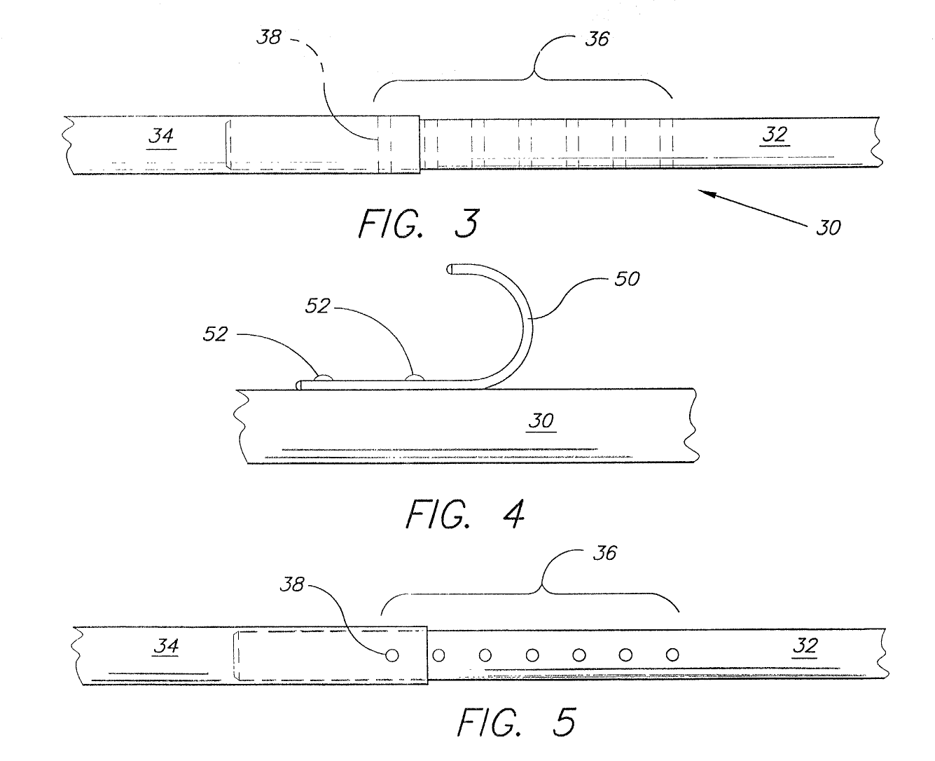

FIGS. 3 and 5 illustrate the adjusting means for selectively adjusting the position of the upper sleeve 34 relative to the lower standard 32. A plurality of holes 36 is formed on the lower standard 32. A hole 38 is located proximate the edge of the upper sleeve 34.

As shown in FIG. 2, a locking pin tee 39 is designed to be inserted in the hole 38 and the aligned hole selected from the plurality of holes 36 on the lower standard 32 to secure the joint. It should be noted that any standard golf tee can be used as a locking pin tee 39, since the novelty golf club and steering wheel lock device 10 is not designed as a functional criminal deterrent and should be used only as a novelty item.

FIG. 4 illustrates the securing means for securing the novelty golf club and steering wheel lock device 10 to the steering wheel SW of a vehicle as a pair of adjustable opposing hooks 50 attached to the club shaft 30. The distance between the opposing hooks 50 is determined by the adjusting means previously described. The opposing hooks 50 are designed to be drawn tightly within the diameter of the steering wheel SW of a vehicle and locked in place with the locking pin tee 39, while each hook 50 grasps the steering wheel SW in opposite directions.

The opposing hooks 50 are made of aluminum and are covered with a polymeric plastic material to prevent scratching the steering wheel SW of a vehicle while being used. Each hook 50 is attached to the shaft 30 with 2 basic metal rivets 52, the technology of with are well-known to those that are skilled in the related art. Specifically, one hook 50 is attached to the lower standard 32 and the other opposing hook 50 is attached to the upper sleeve 34, producing a number of variable distances between hooks 50.

The lower standard 32 and upper sleeve 34 are made of either steel or graphite, like any other functional golf club. There are 7 holes that make up the plurality of holes 36 on the lower standard 32, and therefore, there are 7 possible adjustment settings. This adjustment feature is shown in FIG. 5. The hole 38 on the upper sleeve 34 and the plurality of holes 36 all also have the same diameter, which is wide enough to accommodate a standard golf tee as a locking pin tee 39.

Operation and use of the novelty golf club and steering wheel lock 10 is simple. The locking pin tee 39 should first be removed from the hole 38 on the upper sleeve 34 and one of the plurality of holes 36, to allow for adjustment and fitting of the novelty golf club and steering wheel lock 10 onto the steering wheel SW of a given vehicle. The opposing hooks 50 are then brought together within the diameter of the steering wheel, and are then spread outward so that each hook 50 catches the inside periphery of the steering wheel SW. The locking pin tee 39 is then reinserted into the hole 38 on the upper sleeve 34 and the nearest aligned hole from the plurality of holes 36 and reset to another position.

As indicated earlier, the novelty golf club 10 is not designed as a functional crime deterrent and would be used as a novelty item only. The novelty golf club and steering wheel lock 10 can be any standard golf club such as a wood, iron or putter. The club head 20, hand grip 40 and shaft 30 all meet industry standards and specifications in terms of shape for regular golf clubs.

It is to be understood that the present invention is not limited to the sole embodiment described above, but encompasses any and all embodiments within the scope of the following claims.

I claim:

1. A novelty golf club and steering wheel lock device, comprising:
a club head, a shaft and a hand grip, the shaft having a lower standard portion attached to and extending from the club head and sliding into an upper sleeve portion which continues to extend upward to form the hand grip;
an adjusting means for adjusting the golf club to fit onto a steering wheel of a vehicle; and
a securing means for securing said device to the steering wheel of a vehicle.

2. The device according to claim 1, wherein said adjusting means for selectively adjusting the position of the upper sleeve relative to said lower standard is a plurality of holes formed on the lower standard, a hole near the edge of the upper sleeve and a locking pin designed to be inserted in the hole near the edge of the upper sleeve and a selected and aligned hole from the plurality of holes on the lower standard.

3. The device according to claim 1, wherein said securing means is a pair of adjustable opposing hooks of the same size attached to the shaft.

4. The device according to claim 3, wherein said opposing hooks are made of aluminum with a polymeric plastic coating.
